(19) United States
(12) Patent Application Publication
(10) Pub. No.: US 2026/0008389 A1
(43) Pub. Date: Jan. 8, 2026

(54) METHOD FOR ESTIMATING SURFACE TEMPERATURE OF VENTILATED SEAT

(71) Applicant: GENTHERM INCORPORATED, Novi, MI (US)

(72) Inventors: Ankit TIWARI, Ann Arbor, MI (US); Ayush GARG, Milford, MI (US); Robert FALZON, Redford, MI (US); Tyler MYERS, Plymouth, MI (US); Chad WESTERMAN, Milford, MI (US)

(21) Appl. No.: 19/133,668

(22) PCT Filed: Dec. 20, 2023
(86) PCT No.: PCT/US2023/085086

§ 371 Date: May 28, 2025

Related U.S. Application Data
(60) Provisional application No. 63/434,562, filed on Dec. 22, 2022.

(51) Int. Cl. B60N 2/56; G01K 7/42

(52) U.S. Cl. CPC B60N 2/5642; B60N 2/5635; B60N 2/565; G01K 7/427

(57) ABSTRACT

A method for estimating a surface temperature of a ventilated seat. A heat transfer rate to or from a material layer is determined based on a temperature applied to the material layer by convective air. A temperature of the material layer is estimated based on the heat transfer rate to or from the material layer. A heat transfer rate to or from a trim layer is determined based on the temperature of the material layer, which is applied to the trim layer. A change rate of the surface temperature is calculated based on the heat transfer rate to or from the trim layer. A surface temperature is estimated based on the change rate of the surface temperature.

### CROSS REFERENCE TO RELATED APPLICATIONS

The present application is a national phase application of PCT/US2023/085086 (filed Dec. 20, 2023). which claims priority to U.S. Provisional Application No. 63/434,562 (filed Dec. 22, 2022). which are incorporated herein by reference in their entirety for all purposes.

### FIELD

The present disclosure relates to a method for estimating the temperature of a surface. The surface may be ventilated by convective air flow.

### BACKGROUND

Some climatized vehicle systems operate under a set of predetermined discrete setpoints, which are selected by occupants with the actuation of buttons, dials, and the like. One drawback to these systems is the inability to regulate airflow rate between the setpoints. Another drawback is the need for occupants to manually change airflow rate setpoints during operation of the vehicle to achieve and/or maintain comfort.

To address these challenges, some climatized vehicle systems employ sensors that monitor parameters such as the temperature, blower speed, outside temperature, sun radiation, cabin air temperature. and humidity. The setpoint selected by the occupant is then correlated, via lookup tables, to these parameters and thus the operation of blowers is directed by both the setpoint and the parameters. Noise, vibration, and harshness (NVH) attributed to blowers can also be accounted for. These systems operate under a finite number of pre-determined scenarios. One drawback to these systems is the large degree of calibration effort undertaken to account for the possible scenarios the vehicle may be exposed to. By way of example, systems are typically calibrated to account for driving in different seasons, geographical climates, weather conditions, and the like. Moreover, the calibrations are performed for each make, model, model year, and trim level of vehicle due to the different effects such parameters have on different vehicle builds.

Some climatized vehicle systems calibrate airflow rates to specific cabin air temperatures. However, cabin air temperature does not accurately characterize the temperature felt at surfaces by occupants and is subject to constant fluctuations. While providing a sensor proximate to a surface may detect the temperature felt at that surface, several challenges are realized. Repeatable accuracy and precision in the location of these sensors may be needed for blower operation to cooperate with the system's calibration. However, consistent location of these sensors may be difficult in the manufacturing process. Furthermore, the automotive industry is concerned with cost reduction, so additional sensors with their attendant costs are typically not a favorable solution. Sensors provided in or on compressible layers, such as a spacer layer in a seat, may be felt by occupants, negatively impacting comfort. Moreover, compressible layers expose sensors to repeated wear, which can diminish the integrity of the sensor over time.

Some seats are fabricated with trench lines defined between adjoining portions of material (e.g., adjoining cushion material). Air can follow the trench lines away from the seat surface to which it is intended to be deposited, and thus leak from the system. Conventional methods for controlling ventilated seats do not account for this leakage.

There is a need for a method to accurately and precisely estimate temperatures felt at surfaces by occupants.

There is a need for a method to utilize existing sensor and/or controller hardware to estimate surface temperatures.

There is a need for a method that provides control of blowers to provide a dynamic air flow, unconstrained by pre-determined setpoints.

There is a need for a method that obviates the need for calibrations to populate lookup tables. There is a need for a method to control a blower between discrete setpoints.

There is a need for a method to control a blower across a continuum of possible ambient conditions realized within the cabin of a vehicle.

There is a need for a method to control an operating mode (ON/OFF) and/or setpoints (e.g., low, medium, and high airflow rates) of a blower based on a steady state temperature a seat surface.

### SUMMARY

The present disclosure provides for a method that may address at least some of the needs identified above. The method may estimate a surface temperature of a ventilated seat. The method may comprise determining a heat transfer rate to or from a material layer based on a temperature applied to the material layer by convective air. The method may comprise estimating a temperature of the material layer based on the heat transfer rate to or from the material layer.

The method may comprise determining a heat transfer rate to or from a trim layer based on the temperature of the material layer, which is applied to the trim layer. The method may comprise calculating a change rate of the surface temperature based on the heat transfer rate to or from the trim layer.

The method may comprise updating an estimated surface temperature of the trim layer from a prior program cycle based on the change rate of the surface temperature and the estimated surface temperature of the trim layer from the prior program cycle.

The convective air may flow through one or more vents formed in the material layer and/or a porosity of the material layer.

The convective air may be drawn from a cabin of a vehicle.

The convective air may be free from thermal conditioning by a heating device and/or a cooling device.

The material layer may be a spacer layer disposed between the trim layer and a fluid distribution device.

The method may further comprise determining a second heat transfer rate to or from the trim layer based on a second temperature applied to the trim layer.

The second temperature may be applied by cabin air. The cabin air may be located above the trim layer.

The method may further comprise determining a third heat transfer rate to or from the trim layer based on a third temperature applied to the trim layer.

The third temperature may be applied by an occupant.

The change rate of the surface temperature may be additionally based on the second heat transfer rate and/or the third heat transfer rate.

The method may further comprise determining an occupancy status of the ventilated seat.

For an occupied seat, the change rate of the surface temperature may be additionally based on the second heat transfer rate and the third heat transfer rate.

For an unoccupied seat, the change rate of the surface temperature may be additionally based on the second heat transfer rate.

The heat transfer rates to or from the material layer and the trim layer may be influenced respectively by a thermal resistance of the material layer and a thermal resistance of the trim layer. The thermal resistances of the material layer and the trim layer may be selected based upon if the ventilated seat is occupied or not.

The heat transfer rate to or from the material layer may be influenced by a surface area across which the first temperature is applied. The surface area may be selected based on if the ventilated seat is occupied or not.

The temperature estimated for the material layer and/or the change rate of the surface temperature may be based on one or more additional heat transfer rates.

The one or more additional heat transfer rates relative to the material layer may include a heat transfer rate between a fluid distribution device and the material layer.

The first temperature may be sensed by a sensor local to the cabin of the vehicle in which the ventilated seat is located.

The method may further comprise controlling a blower, including: receiving the surface temperature: receiving a cabin air temperature: optionally receiving a relative humidity: and regulating a duty cycle of the blower based on the surface temperature, the cabin air temperature, the relative humidity, or any combination thereof.

The present disclosure provides for a system that may address at least some of the needs identified above. The system may perform the method described above. The system may comprise: a blower operating in either push or pull mode: a fluid distribution device (e.g., in the form of a bag), a portion thereof that is oriented toward a seat surface being air permeable: a temperature sensor (e.g., located on-board the blower); and a relative humidity sensor (e.g., located proximate to the seat surface).

### BRIEF DESCRIPTION OF THE DRAWINGS

FIG. 1 illustrates a ventilated scat.

FIG. 2 is a schematic of the system of the present teachings.

FIG. 3 is a flowchart of the method of the present teachings.

### DETAILED DESCRIPTION

The present disclosure provides a method for dynamically estimating the temperature of a surface. The surface may be any exposed surface of a vehicle component. The vehicle component and the exposed surface thereof may be located within the cabin of the vehicle. The surface may be on a trim layer. That is, the exposed, visible surfaces of the vehicle commonly contacted by occupants (e.g., leather, fabric, or the like). The vehicle component may include any component contacted by an occupant.

The surface may exchange heat with convective air, one or more material layers, an occupant, cabin air, radiative heat sources, or any combination thereof. The convective air may be drawn into the surface and/or expelled from the surface. The convective air may travel through one or more material layers located underneath the surface.

The vehicle component may include a seat. The seat may comprise a back portion, one or more back bolsters, a seat portion, one or more seat bolsters, a headrest, or any combination thereof. The seat may be ventilated. That is, convective air may flow through the seat, influence the temperature of the seat, draw heat away from an occupant, draw moisture away from an occupant, force air to an occupant, or any combination thereof.

Typically, a vehicle seat may be laid-up with a trim layer, a fluid distribution device, and one or more material layers (e.g., a spacer layer) disposed therebetween.

Occupants may sit upon and/or contact one or more surfaces of a seat. These surfaces may be referred to herein alternatively as trim layers. The trim layer may comprise one or more vents and/or be fabricated from a porous material. Thus, convective air flow may pass through the trim layer. The trim layer may comprise fabric, leather, the like, or any combination thereof.

Typically, one or more material layers may separate a fluid distribution device from a trim layer. The material layer may function to protect the fluid distribution device, provide comfort to occupants, regulate the heat transfer rate through the material layer by virtue of the material and thickness of the material layer, facilitate air flow therethrough, or any combination thereof. The material layer may comprise one or more woven fabrics, non-woven fabrics, films, leathers, foams, meshes, air pockets, or any combination thereof.

The material layer may comprise one or more vents. The vents may extend at least partially from one side of the material layer to an opposing side of the material layer. The vents may direct air flow between the trim layer and the fluid distribution device. Air may travel through the vents.

The material layer may be porous. The porosity of the material layer may allow air to flow through the material layer. By way of example, the material layer may be fabricated of open-cell foam. The present disclosure contemplates that both a porous material layer and vents formed in the material layer may be employed.

Although the present disclosure discusses an arrangement of one material layer (e.g., a spacer layer) disposed between a fluid distribution device and the trim layer, other layer arrangements are contemplated by the present disclosure. For example, two or more, or even three or more material layers.

Moreover, the present disclosure contemplates a fluid distribution device disposed in direct contact with a trim layer. In this arrangement, the heat transfer rate between the fluid distribution device and the trim layer may be calculated in accordance with the present teachings.

The fluid distribution device may function to distribute air across a surface area (in push mode) or collect air from across a surface area (in pull mode). The fluid distribution device may comprise one or more channels and/or enclosures through which air flows. The fluid distribution device may define an inner volume through which air flows.

In some aspects, the material layer may define at least a portion of the fluid distribution device. For example, a layer of a seat may comprise one or more channels formed therein, the channels being exposed or open on a surface of said layer; the spacer layer may be disposed onto the layer and over the one or more channels to define an enclosed volume of the one or more channels through which air may travel.

The enclosure may be rigid, flexible, or both. The enclosure may comprise a bag. The enclosure may comprise one or more portions that are air permeable. The one or more portions may be oriented toward the direction of the occupant.

The fluid distribution device may comprise a spacer material. The spacer material may at least partially prevent compression of the seat from pinching opposing surfaces of the fluid distribution device and restricting airflow. In regard to flexible fluid distribution devices, the spacer material may maintain a spacing between opposing surfaces of the fluid distribution device. The spacer material may comprise mesh. foam, woven textile, non-woven textile, or any combination thereof. The spacer material may be air permeable.

In push mode, air may be directed across a surface area of a material layer and/or trim layer by the fluid distribution device. Air may be directed to vents formed in the material layer and/or porosity in the material layer. Air may be directed to vents formed into the trim layer and/or porosity in the trim layer. The air may be vented towards an occupant.

In pull mode, air may be drawn from the surface of the seat and into the fluid distribution device. The air may be expelled at a port of the fluid distribution device. The air may be ultimately expelled to the cabin of the vehicle. The port may fluidly communicate with one or more blowers.

Non-limiting examples of ventilated seats are described in U.S. Pat. No. 7,735,932 B2 and International Publication No. WO 2007/142972 A2, both of which are incorporated herein by reference for all purposes.

The ventilation may be regulated by one or more blowers. Non-limiting examples of blowers are described in International Publication No. WO 2008/115831 A1 and U.S. Pat. No. 9,121,414 B2, incorporated herein by reference for all purposes.

The blower may be controlled to provide an airflow that corresponds with an operation mode and/or a setpoint. The operation mode may be ON or OFF. The setpoint may include a temperature setpoint, an airflow rate setpoint, or both. The setpoints may be selected from a range of setpoints.

The operation mode and/or setpoint may be determined by occupants' actuation of one or more knobs, buttons, dials, toggles, switches, the like, or any combination thereof (also referred to herein as a human-machine interface).

The operation mode and/or setpoint may be determined by an autonomous control system. These systems may account for one or more sensor inputs and regulate the setpoints autonomously via one or more controllers. The autonomous control system may operate in cooperation with inputs from the the human-machine interface.

The blower may be operated by a duty cycle (e.g., pulse width modulation). The duty cycle may be selected to achieve a desired airflow rate.

The dynamic temperature estimation of the present disclosure accounts for the complex system of heat exchanges that occur throughout the vehicle. Outside temperature, humidity, sun radiation, occupants body temperature, cabin air temperature, and/or the temperature of vehicle components may contribute to such heat exchanges. Moreover, these parameters may change over time due to the operation of one or more blowers and/or the changing environment within and/or outside the vehicle. Particularly, the present disclosure is concerned with heat exchanges that originate from or ultimately travel to the body of an occupant. In this manner, thermal comfort may be provided to occupants. One exemplary model of heat transfer relative to the human body in transient, non-uniform environments is discussed in Huizenga et al., A model of human physiology and comfort for assessing complex thermal environments, Center for Environmental Design Research, University of California, Berkeley, CA 94720-1839.

The dynamic estimation may be based on principles of physics. One or more heat transfer rates may be calculated, and a surface temperature may be estimated based on the heat transfer rates. The rate of heat transfer between two mediums may be generally based on the difference in temperature between the two mediums, the surface area across which the heat transfer is occurring, one or more thermal resistances. or any combination thereof.

The method of the present disclosure may estimate the temperature of a surface and continuously update the temperature estimation. Thus, the method of the present disclosure may adapt to constantly fluctuating ambient cabin conditions. Ambient cabin conditions may refer to the volume of air within the cabin of the vehicle, such as surrounding the occupant. The method of the present disclosure may adapt in real-time, providing consistent thermal comfort to occupants.

The present disclosure provides for a unique method that may rely on the inputs from the existing sensors that measure the temperature of air, sensors that detect the presence of occupants, any other existing sensors in the vehicle, or any combination thereof. The temperature sensor may include a negative temperature coefficient (NTC) resistor, a resistance temperature detector (RTD), a thermocouple, a semiconductor-type sensor, or any combination thereof. Thus, the method of the present disclosure may not require temperature sensors to be located on or proximate to a surface to which an airflow is provided.

A non-limiting example of an occupancy sensor is described in U.S. Pat. No. 7,205,902 B2 (describing a sensor used in the activation of an air bag), incorporated herein by reference for all purposes. Non-limiting examples of occupancy sensors that detect occupants' contact with vehicle components (e.g., steering wheels or gear shifters) are described in U.S. Pat. No. 9,266,454 B2 (describing, e.g., capacitance sensors, pressure sensors, etc.), incorporated herein by reference for all purposes.

The dynamic estimation may be based on a relatively small set of pre-determined values compared to conventional methods and systems. These values may include thermal resistances, thermal capacitances, surface areas, ratios of occupied surface area to unoccupied surface area, or any combination thereof. These values are non-limiting and others may be realized by the present disclosure. These values may be stored in a memory storage medium (e.g., a non-transitory memory storage medium).

One or more heat transfer rates may be dynamically estimated based on one or more of the foregoing inputs. The heat transfer rates may include those between cabin air and a surface, between an occupant and a surface, between a material layer (e.g., spacer layer) and a surface, between one or more air distribution devices and a material layer, between convective air and one or more material layers, between convective air and a trim layer, between a first material layer and a second material layer, or any combination thereof. These heat transfer rates are non-limiting and other heat transfer rates may be realized by the present disclosure.

The dynamic estimation may employ one or more look-up tables, transfer functions, equations, or any combination thereof. Preferably, the dynamic estimation may be determined by one or more equations and/or transfer functions characterizing the physics principles of heat transfer between mediums. The equations and/or transfer functions may be provided inputs by sensors, calculations from prior program cycles, pre-determined values (e.g., thermal resistances, thermal capacitances, cycle times, and surface areas), or any combination thereof. Sensor inputs may be obtained in real-time. Prior program calculations and/or pre-determined values may be obtained from a memory storage medium (e.g., a non-transitory memory storage medium).

The method of the present disclosure may bridge the gap between the analytical theory and the actual application. In this regard, some approximations and/or assumptions may be made for the real-life operation of blowers to cooperate with the analytical theory. The concept of lump capacitance may be employed to this end. That is, a three-dimensional solid object undergoing a changing thermal environment can be assumed to be at a uniform bulk temperature thus neglecting temperature gradients throughout the thickness of the object.

Parameters including thermal resistance, thermal capacitance, and surface area may be pre-determined. The parameters may be measured. The parameters may be stored in a memory storage medium (e.g., non-transitory storage medium). The parameters may be provided in a look-up table. The parameters may be unique to different materials, layer thicknesses, and the like. Thus, different makes, models, and model years, with different vehicle component builds, may be associated with different parameters.

Parameters including thermal resistance, thermal capacitance, and surface area may be adjusted to achieve a dynamic temperature estimation that cooperates with the actual temperature of an element. In this regard, calibration efforts may involve performing the present method in a controlled environment with sensors measuring the actual temperatures of seat elements such that the dynamically estimated temperature can be compared to the measured temperature. As a result, one or more values may be adjusted such that the dynamically estimated temperature cooperates with the measured temperature.

Estimation, as referred to herein, may mean the calculation of a parameter understanding that the result of such calculation may not exactly correspond with the actual value (e.g., temperature of a surface). Thus, the result of such calculation may be an estimate of the actual value. The method of the present disclosure may provide an estimate that deviates about 10% or less, more preferably 5% or less, or even more preferably 1% or less from the actual value.

Dynamic, as referred to herein, may mean an estimation that is reactive to changing conditions (e.g., cabin temperature, occupancy status, and the like). That is, as temperatures are dynamically estimated. they are employed in subsequent program cycles for further dynamic temperature estimations.

Any calculation, dynamic estimation, storage, transmission, and/or obtaining step recited herein may be performed by one or more controllers. The controllers may include one or more dedicated effector controllers, vehicle controllers, or both. Calculations and dynamic estimations may be performed by one controller or distributed between a plurality of controllers. Any pre-determined values or inputs may be stored locally on and/or remote from the controllers. Any inputs that are calculated or estimated from prior program cycles may be stored locally on and/or remote from the controllers. Any inputs from one or more prior program cycles may be stored temporarily on and/or remote from the controllers. Any calculated or estimated inputs from one or more prior program cycles may be replaced or updated by calculated or estimated inputs from a current program cycle. The foregoing is applicable to all embodiments.

Any communication or transmission between different controllers, sensors, and/or other devices described herein may be via a local interconnect network (LIN) bus. Communications or transmissions may occur from a sensor to a controller or from a controller to another controller. By way of example but not limitation, an occupancy sensor may transmit an occupancy status to a vehicle controller, and then the vehicle controller may transmit the occupancy signal to a dedicated effector controller. The foregoing is applicable to all embodiments.

Vehicle, as referred to herein, may mean any automobile, recreational vehicle, sea vessel, air vessel, the like, or any combination thereof. While the present disclosure discusses convective heat transfers of a vehicle seat, the teachings herein may be adapted for any object acted upon by convective heat transfers. By way of example, the present teachings may be applied to furniture (e.g., chairs and beds), buildings, the like, or any combination thereof.

### Dynamically Estimating Surface Temperature

The method may comprise dynamically estimating the surface temperature of a trim layer (Tₑₛₜ). The surface temperature may be dynamically estimated based on the heat transfer rates of the trim layer to or from one or more surrounding mediums. The surface temperature may be dynamically estimated based on the heat transfer rate between a material layer and the trim layer (\dot{Q}ₘₐₜₑᵣᵢₐₗ), the heat transfer rate between cabin air and the trim layer (\dot{Q}_{cab}), the heat transfer rate between an occupant and the trim layer (\dot{Q}_{cce}), the heat transfer rate between any number of other sources and the trim layer (\dot{Q}ₒₜₕₑᵣ), or any combination thereof.

The change in temperature of the trim layer per unit time (\dot{T}) may be determined from the foregoing heat transfer rates and the thermal capacitance of the trim layer (C).

With a known program cycle time (t) (e.g., 1 second or less, 50 milliseconds or less, 30 milliseconds or less, or even 10 milliseconds or less), a temperature change (ΔT) over the cycle duration may be determined from the change in temperature of the trim layer per unit time, per the following equation.

$$\dot{T} \times t = Δ T \qquad Eq . A$$

The temperature change may be added to the initial or prior surface temperature (T₍ₙ₋₁₎) to obtain the estimated surface temperature of the trim layer (Tₑₛₜ), per the following equation.

$${T}_{( n - 1 )} + Δ T = {T}_{e s t} \qquad Eq . B$$

Before start-up, the initial surface temperature may be used. The initial surface temperature may be assumed to be equal to the temperature sensed by a local sensor upon start-up. That is, as a vehicle sits for a period of time in an environment prior to start-up, the temperature of the air and vehicle components within the cabin may normalize. The local sensors may include those disposed in the cabin, on heating elements, in vent outlets, or otherwise. Any sensors located in the vehicle may provide the temperature at start-up.

After start-up, the prior surface temperature may be used. The prior surface temperature may be the estimated surface temperature from a prior program cycle.

The methods for determining the heat transfer rate between a material layer and the trim layer (\dot{Q}ₘₐₜₑᵣᵢₐₗ), the heat transfer rate between cabin air and the trim layer (\dot{Q}_{cab}), the heat transfer rate between an occupant and the trim layer (\dot{Q}_{occ}), and the heat transfer rate between any number of other mediums (\dot{Q}ₒₜₕₑᵣ) are provided hereunder.

### Occupancy Detection

The method may comprise obtaining an occupancy status of a seat. The occupancy status may characterize whether an occupant is or is not present in a seat. The occupancy status may be provided by the vehicle using existing sensors, such as occupancy sensors for the operation of air bags. The occupancy status may be relevant to the thermal resistance and/or surface areas through which heat transfer occurs.

A seat that is occupied may result in compression of a trim layer, one or more material layers, a fluid distribution device, or any combination thereof. Compression may influence the thermal resistances discussed herein, as the thickness through which heat is travels is different in a compressed seat versus an uncompressed seat. Compression may influence surface area, discussed herein.

The method of the present disclosure may be performed on a seat that is unoccupied. The method of the present disclosure may be performed whether or not an ON command is provided to one or more blowers. In this manner, the initial surface temperature may be known and at any time an occupant enters the vehicle and/or contacts a seat. This may be useful for a vehicle that is pre-conditioned (e.g., a vehicle equipped with auto-start) and/or for passengers who enter the vehicle at some point in time after start-up.

### Heat Transfer Rate Between Convective Air and the Material Layer

The method may comprise determining the heat transfer rate between convective air and the material layer (\dot{Q}_{conv}).

Convective air may flow through the air distribution device, into vents formed in the material layer and/or porosity thereof, and to the trim layer. As the convective air travels through the vents formed in the material layer it may exchange heat with the material layer.

Convective air may flow through trench lines in the seat. Trench lines may be defined between abutting sections of the seat. By way of example, air may flow between the fluid distribution device and the spacer layer, between the spacer layer and the trim layer, or the like. The surface area of convective heat transfer, discussed herein, may be calibrated to account for trench lines. That is, the surface area employed in the present method may be adjusted to account for trench lines.

The heat transfer rate may be a function of the temperature of convective air (T_{conv}), the temperature of the material layer (Tₘₐₜₑᵣᵢₐₗ), the surface area (A) of the material layer with which the convective air thermally communicates, the thermal resistance (R) of the material layer, or any combination thereof. The heat transfer rate may be determined by the following equation.

$${\dot{Q}}_{c o n v} = \frac{( {T}_{m aterial} - {T}_{c o n v} ) \times A}{R} \qquad Eq . C$$

The convective air temperature may be provided by one or more local sensors located in the cabin of the vehicle. The convective air temperature may be assumed equal to the cabin air temperature. The convective air temperature may be provided by one or more sensors located in a blower, a conduit extending between the blower and the fluid distribution device, the fluid distribution device, or any combination thereof.

The temperature of the material layer may be assumed to be equal to a temperature sensed by a local sensor upon start-up. That is, it may be assumed that the temperature of the material layer is equal to the temperature of the cabin environment. After start-up, the temperature of the material layer may be obtained from a prior program cycle. The temperature of the material layer determined by a program cycle of the present method is discussed further below.

The surface area may include the surface area of the material layer that convective air thermally communicates with. This may include the collective surface area of vents extending through the material layer, the surface area of the porosity of the material layer, the surface area of the material layer contacted by the fluid distribution device, or any combination thereof. Moreover, the surface area may account for trench lines within the seat. The surface area of the material layer may characterize whether the seat is occupied (A_{occ}) or unoccupied (A_{unocc}). That is, compression of the material layer may influence the surface area with which the convective air thermally communicates.

The thermal resistance of the material layer may characterize whether the seat is occupied (R_{occ}) or unoccupied (R_{unocc}). That is, compression of the material layer may influence the thermal resistance thereof.

### Heat Transfer Rate Between the Material Layer and the Trim Layer

The method may comprise determining the heat transfer rate between the material layer and the trim layer (\dot{Q}ₘₐₜₑᵣᵢₐₗ).

The temperature of the material layer may be influenced by the convective air flowing through the material layer. The material layer may exchange heat with the trim layer by conduction, convection, or both.

The heat transfer rate may be a function of the temperature of the material layer (Tₘₐₜₑᵣᵢₐₗ), the temperature of the trim layer (Tₜᵣᵢₘ), the surface area (A) over which the material layer thermally communicates with the trim layer, the thermal resistance (R) of the trim layer, or any combination thereof. The heat transfer rate may be determined by the following equation.

$${\dot{Q}}_{m a t e r i a l} = \frac{( {T}_{trim} - {T}_{m aterial} ) \times A}{R} \qquad Eq . D$$

The temperature of the trim layer may be assumed to be equal to a temperature sensed by a local sensor upon start-up. That is, it may be assumed that the temperature of the trim layer is equal to the temperature of the cabin environment. After start-up, the temperature of the trim layer may be obtained from a prior program cycle. The temperature of the trim layer may be determined by a program cycle of the present method.

The temperature of the material layer may be determined as discussed hereinbefore.

The surface area may include the surface area of the trim layer that material layer thermally communicates with.

The thermal resistance of the trim layer may characterize whether the seat is occupied (R_{occ}) or unoccupied (R_{unocc}). That is, compression of the trim layer may influence the thermal resistance thereof.

### Dynamically Estimating Material Layer Temperature

Based on the foregoing heat transfer rates relative to the material layer, the temperature of the material layer (Tₘₐₜₑᵣᵢₐₗ) may be dynamically estimated.

The temperature of the material layer may be a function of the initial or prior temperature of the material layer (Tₘₐₜₑᵣᵢₐₗ₍ₙ₋₁₎), the sum of the heat transfer rates relative to the material layer, the thermal capacitance of the material layer (C), and the program cycle time (Δt). The temperature of the material layer may be dynamically estimated by the following equation.

$${T}_{m a t e r i a l} = {T}_{m a t e r i a l ( n - 1 )} + \frac{\sum \dot{Q}}{C} \times Δ t \qquad Eq . E$$

The initial temperature of the material layer may refer to the temperature sensed by a local sensor upon start-up, as discussed above. The prior temperature of the material layer may refer to the temperature from a prior program cycle, as discussed above.

### Heat Transfer Rate between Environment and/or Occupant and Trim Layer

The method may comprise calculating the heat transfer rate between the cabin air and the trim layer (\dot{Q}_{cab}).

The method may comprise obtaining an occupancy status, as described hereinbefore. If the seat is unoccupied, the heat transfer rate between the cabin air and the trim layer may be calculated. If the seat is occupied, the heat transfer rate between the cabin air and the trim layer, and the heat transfer rate between the occupant's skin and the trim layer may be calculated. Both heat transfer rates relative to the trim layer may be determined due to different portions of the seat thermally communicating with each. By way of example, while an occupant is seated the areas between an occupant's legs and the area around the peripheral edges of the seat may thermally communicate with the cabin air.

The heat transfer rate relative to the cabin air may be a function of the temperature of the cabin (T_{cab}), the temperature of the trim layer (Tₜᵣᵢₘ), the thermal resistance of free convective air (R), the surface area through which heat transfer occurs (A), or any combination thereof. The heat transfer rate relative to cabin air may be determined by the following equation.

$${\dot{Q}}_{c a b} = \frac{( {T}_{c a b} - {T}_{trim} ) \times A}{R} \qquad Eq . F$$

The heat transfer rate relative to the occupant may be a function of the temperature of the occupant's skin (Tₛₖᵢₙ), the temperature of the trim layer (Tₜᵣᵢₘ), the combined thermal resistance of clothing (R_{clo}) and skin (Rₛₖᵢₙ), the surface area through which heat transfer occurs (A), or any combination thereof. The heat transfer rate relative to the occupant may be determined by the following equation.

$${\dot{Q}}_{s k i n} = \frac{{T}_{s k i n} - {T}_{trim} \times A}{( {R}_{c l o} + {R}_{s k i n} )} \qquad Eq . G$$

It is understood that one or both heat transfer rates may be determined based on the occupancy status of the seat. Moreover, the surface area may be selected based on the occupancy status of the seat. Given a known surface area of the seat, one or more first portions of the surface area may thermally communicate with the cabin air and one or more second portions of the surface area may thermally communicate with the occupant.

The cabin air temperature may be provided by a local sensor.

The skin temperature may be set to a fixed value (e.g., a value within the normal human skin temperature range of 33° C, to 37° C.). The skin temperature may be modelled as a function of trim layer temperature, cabin air temperature, blower operation, or any combination thereof. The skin temperature may be determined by one or more sensors.

The trim layer temperature may be assumed equal to the temperature sensed by a local sensor upon start-up of the vehicle. The trim layer temperature may be provided by a dynamic estimation, taught herein, after start-up of the vehicle.

The thermal resistance of clothing may depend on geographic region, season, the body part being conditioned, or any combination thereof. The foregoing may inform assumptions of clothing worn by occupants. In regions where the climate is temperate, heavier clothing (e.g., jackets) may be worn during colder months and lighter clothing (e.g., t-shirts) may be worn during warmer months. In regions where the climate is tropical, lighter clothing may be worn year-round. Moreover, the clothing worn may depend on the body part being conditioned. By way of example, pants worn in colder months may have a thermal resistance that is approximately comparable (e.g., 10% deviation or less) to shorts worn in warmer months. On the other hand, where the torso is being conditioned, jackets worn in colder months may have a greater thermal resistance than shirts worn in warmer months.

### Blower Control

The dynamically estimated surface temperature of the trim layer may be employed in the operation of one or more blowers. Based upon the dynamic estimation of surface temperature, the duty cycle and/or ON/OFF command of a blower may be controlled.

The one or more blowers may be programmed to operate in push mode or pull mode. In push mode. air is first drawn into a blower and pushed to the surface. In pull mode, air is first drawn into the seat from the surface and pulled to the blower.

Air drawn into the blower in push mode may be drawn from underneath the seat and/or a region proximate to the underside of the seat. Air pulled to the blower in pull mode may be drawn from the surface of the trim layer and/or a region proximate to the surface of the trim layer.

Seat ventilation may function to draw heat away from the seat, provide a cooling sensation to the occupant, draw moisture from the occupant, force air to the occupant, or any combination thereof.

A blower may be operated to achieve a steady state of surface temperature. In this regard, heat from the occupant that is absorbed by the seat and/or heat absorbed by the seat while soaking in hot environment may be drawn away from the seat. The dynamically estimated surface temperature may be monitored, and the blower may be turned off or airflow rate downregulated between setpoints when steady state is achieved. The blower may be upregulated between setpoints if the dynamically estimated surface temperature exceeds a threshold.

A blower may be operated to provide a cooling sensation to the occupant. In this regard, convective air may draw heat away from dry skin of an occupant or draw moisture away from an occupant. A relative humidity sensor may be provided in the seat to detect moisture.

The cabin air temperature may be compared to a low and/or high threshold to determine if the blower should be turned OFF or at least downregulated. As convective air is ventilated through the seat, the temperature of the cabin air may provide discomfort to occupants. This may occur in a vehicle that is soaked in freezing or near-freezing temperatures as well as a vehicle that is soaked in hot temperatures.

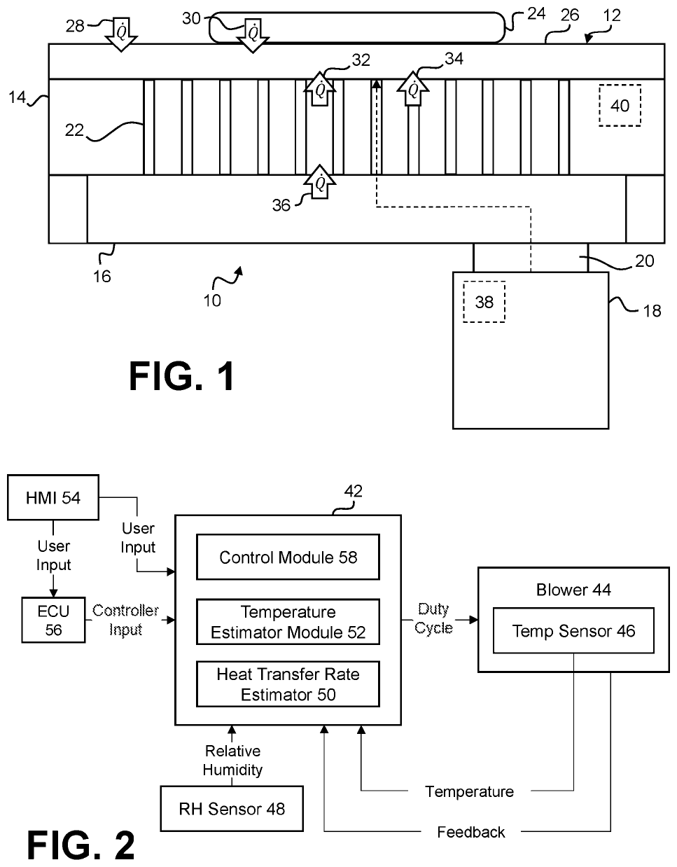

FIG. 1 illustrates a seat 10. The seat 10 comprises a layered build of a trim layer 12, a spacer layer 14, and a fluid distribution device 16. A blower 18 is located on an underside of the seat 10, although the present teachings contemplate that the blower 18 may be located to a side of or within the fluid distribution device 16, and is fluidly connected to the fluid distribution device 16, with a conduit 20 disposed therebetween. The present teachings contemplate that a conduit 20 may or may not be present and if not present, the blower 18 may be directly connected to the fluid distribution device 16. Moreover, the conduit 20 may be extended in length to suit various positions of the blower 18 relative to the seat 10. In this regard, the conduit 20 may comprise one or more bends.

FIG. 1 illustrates a seat portion of a seat 10; however, the present teachings contemplate the same or even a similar arrangement may be provided in a back portion or any other portion of a seat 10. A seat 10 may be provided with the illustrated device in both the seat portion and the back portion and optionally any other portion of the seat 10.

Air from the underside of the seat 10 may be drawn into an inlet of the blower 18 and expelled through an outlet of the blower 18, ultimately entering and filling the fluid distribution device 16. The air travels through a plurality of channels 22, formed in the spacer layer 14, to the trim layer 12, thus conditioning an occupant 24 contacting the surface 26 of the trim layer 12. This manner of airflow may be referred to as push mode (i.e., air pushed by the blower toward the occupant), one exemplary path of which is illustrated proceeding through the seat 10 in broken lines. The present teachings contemplate operation in the opposite manner, referred to as pull mode (i.e., air pulled away from the occupant by the blower).

The trim layer 12 thermally communicates with the occupant 24 and/or the ambient air (“environment”) proximate to the trim layer 12. In one aspect, a seat 10 may be unoccupied, and in this regard the trim layer 12 only thermally communicates with the ambient air. In another aspect, a seat 10 may be occupied, and in this regard a portion of the trim layer 12 thermally communicates with the occupant 24 while another portion of the trim layer 12 thermally communicates with the ambient air (e.g., in an area between the occupant's legs, in the bolster regions of the seat, and the like).

Heat transfer rates to the trim layer 12 are illustrated and include a heat transfer rate relative to the environment 28, a heat transfer rate relative to the occupant 30, a heat transfer rate relative to the spacer layer 32, and a heat transfer rate relative to convective air 34. Moreover, the fluid distribution device 16 and the spacer layer 14 thermally communicate with each other, thus a heat transfer relative to the fluid distribution device 36 is present. As illustrated, the heat transfer rates are all oriented to the trim layer 12, although the present teachings contemplate the heat transfer rates oriented in the opposing direction, depending on the relative temperatures of two thermally communicating mediums.

The present method dynamically estimates the temperature of a thermal medium (e.g., a trim layer, a spacer layer, a fluid distribution device, etc.) based upon one or more calculated heat transfer rates to and/or from the thermal medium. Ultimately the temperature of a surface contacted by an occupant may be dynamically estimated and utilized in the control of the blower. In this regard, a temperature sensor 38 and optionally a relative humidity sensor 40 may be employed. As illustrated, the temperature sensor 38 is located in the blower 18 and the relative humidity sensor is located in the spacer layer 14, however, the present teachings contemplate that the sensors may be located anywhere that is practicable in view of the present teachings.

FIG. 2 is a schematic of a system for performing the method of the present teachings. The system comprises a controller 42 that receives inputs from a blower 44, a temperature sensor 46, and a relative humidity sensor 48. Based on an input from the temperature sensor 46, a heat transfer rate estimator module 50 can output a heat transfer rate. Based on the heat transfer rate and optionally one or more other heat transfer rates, a temperature estimator module 50 can output a temperature.

The system comprises a human-machine interface (“HMI”) 54, which an occupant can actuate to provide user inputs by selecting an operating mode (e.g., ON/OFF) and/or a setpoint such as a temperature setpoint and/or a airflow rate setpoint (e.g., levels 1, 2, and 3) (“user inputs”). The user inputs may be signally communicated directly to the controller 42 and/or to any vehicle controller such as an engine control unit (“ECU”) 56. The ECU 56 processes the user input to generate a controller input and provides the controller input to the controller 42.

The controller 42 comprises a control module 58 that functions to control a duty cycle and/or ON/OFF mode of the blower 44. The duty cycle is a function of the user input and/or controller input, relative humidity, one or more temperature estimations, or any combination thereof.

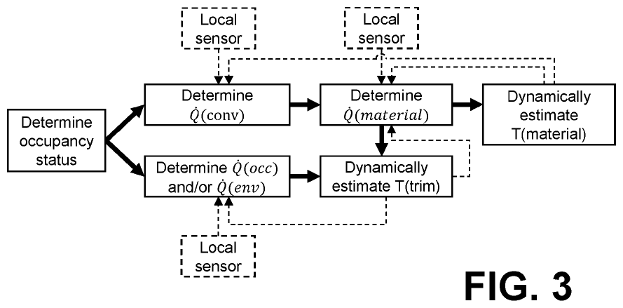

FIG. 3 is a flowchart of the method of the present teachings. Transitions between method steps are denoted by solid black arrows and inputs used in the calculations are denoted by dashed arrows.

The method comprises determining the occupancy status of the seat, which influences the selection of parameters including thermal resistance, thermal capacitance, and surface area.

The method comprises determining the heat transfer rate between the convective air flow and the spacer layer. The temperature of the convective air is provided by a local sensor disposed within the cabin of the vehicle. The temperature of the spacer layer is provided by the dynamic estimation from a prior program cycle. It is understood that prior to start-up, the temperature of the spacer layer may also be provided by the local sensor, as discussed herein.

The method comprises determining the heat transfer rate between the spacer layer and the trim layer. The temperatures of the spacer layer and the trim layer are provided by a local sensor disposed within the cabin of the vehicle prior to start-up. The temperatures of the spacer layer and the trim layer are provided by dynamic estimations from a prior program cycle.

The method comprises determining the heat transfer rate between the occupant and the trim layer and/or the cabin environment and the trim layer. The temperature of the trim layer is provided by a local sensor upon start-up. The temperature of the trim layer is provided by the dynamic estimation from a prior program cycle after start-up.

The method comprises dynamically estimating the temperature of the material layer and the temperature of the trim layer based on associated heat transfer rates. The dynamically estimated temperatures may be employed in subsequent program cycles.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The method may comprise one or more of the steps recited herein. Some of the steps may be duplicated, removed or eliminated, rearranged relative to other steps, combined into one or more steps, separated into two or more steps, or a combination thereof.

The flow charts described herein do not imply a fixed order to the steps, and embodiments of the present invention may be practiced in any order that is practicable, unless otherwise specified herein.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer or section without departing from the teachings.

Spatially relative terms, such as “inner,” “outer,” “beneath,” “below,” “lower,” “above,” “upper,” and the like, may be used herein for case of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

### REFERENCE NUMERALS

10 Seat
12 Trim layer
14 Spacer layer
16 Fluid distribution device
18 Blower
20 Conduit
22 Channel
24 Occupant
26 Surface
28 Heat transfer relative to environment
30 Heat transfer relative to occupant
32 Heat transfer relative to spacer layer
34 Heat transfer relative to convective air
36 Heat transfer relative to fluid distribution device
38 Temperature sensor
40 Relative humidity sensor
42 Controller
44 Blower
46 Temperature sensor
48 Relative humidity sensor
50 Heat transfer rate estimator module
52 Temperature estimator module
54 Human-machine interface
56 Engine control unit
58 Control module

What is claimed is:

1. A method for estimating a surface temperature of a ventilated seat, the method comprising:
determining a heat transfer rate to or from a material layer based on a temperature applied to the material layer by convective air;
estimating a temperature of the material layer based on the heat transfer rate to or from the material layer;
determining a heat transfer rate to or from a trim layer based on the temperature of the material layer, which is applied to the trim layer;
calculating a change rate of the surface temperature based on the heat transfer rate to or from the trim layer; and
updating an estimated surface temperature of the trim layer from a prior program cycle based on the change rate of the surface temperature and the estimated surface temperature of the trim layer from the prior program cycle.

2. The method according to claim 1, wherein the convective air flows through one or more vents formed in the material layer and/or a porosity of the material layer.

3. The method according to claim 2, wherein the convective air is drawn from a cabin of a vehicle.

4. The method according to claim 3, wherein the convective air is free from thermal conditioning by a heating device and/or a cooling device.

5. The method according to claim 1, wherein the material layer is a spacer layer disposed between the trim layer and a fluid distribution device.

6. The method according to claim 1, wherein the method further comprises determining a second heat transfer rate to or from the trim layer based on a second temperature applied to the trim layer.

7. The method according to claim 6, wherein the second temperature is applied by cabin air; optionally wherein the cabin air is located above the trim layer.

8. The method according to claim 1, wherein the method further comprises determining a third heat transfer rate to or from the trim layer based on a third temperature applied to the trim layer.

9. The method according to claim 8, wherein the third temperature is applied by an occupant.

10. The method according to claim 1, wherein the change rate of the surface temperature is additionally based on the second heat transfer rate and/or the third heat transfer rate.

11. The method according to claim 10, wherein the method further comprises determining an occupancy status of the ventilated seat.

12. The method according to claim 11, wherein for an occupied seat, the change rate of the surface temperature is additionally based on the second heat transfer rate and the third heat transfer rate.

13. The method according to claim 12, wherein for an unoccupied seat, the change rate of the surface temperature is additionally based on the second heat transfer rate.

14. The method according to claim 1, wherein the heat transfer rates to or from the material layer and the trim layer are influenced respectively by a thermal resistance of the material layer and a thermal resistance of the trim layer; and wherein the thermal resistances of the material layer and the trim layer are selected based upon if the ventilated seat is occupied or not.

15. The method according to claim 14, wherein the heat transfer rate to or from the material layer is influenced by a surface area across which the first temperature is applied; and wherein the surface area is selected based on if the ventilated seat is occupied or not.

16. The method according to claim 15, wherein the temperature estimated for the material layer and/or the change rate of the surface temperature are based on one or more additional heat transfer rates.

17. The method according to claim 16, wherein the one or more additional heat transfer rates relative to the material layer includes a heat transfer rate between a fluid distribution device and the material layer.

18. The method according to claim 1, wherein the first temperature is sensed by a sensor local to the cabin of the vehicle in which the ventilated seat is located.

19. The method according to claim 1, further comprising controlling a blower including:
receiving the surface temperature;
receiving a cabin air temperature;
optionally receiving a relative humidity; and
regulating a duty cycle of the blower based on the surface temperature, the cabin air temperature, the relative humidity, or any combination thereof.

20. A system for performing the method according to claim 19, the system comprising:
a blower operating in either push or pull mode;
a fluid distribution device (e.g., in the form of a bag), a portion thereof that is oriented toward a seat surface being air permeable;
a temperature sensor (e.g., located on-board the blower); and
a relative humidity sensor (e.g., located proximate to the seat surface).
